(19) United States
(12) Patent Application Publication
(10) Pub. No.: US 2014/0193125 A1
(43) Pub. Date: Jul. 10, 2014

(54) PRESSURE RESISTANT MEDIA CONVERTER APPARATUS

(71) Applicants: Richard C. E. Durrant, Crystal Lake, IL (US); Igor G. Stouklov, Walnut, CA (US); Mark C. Benton, Itasca, IL (US)

(72) Inventors: Richard C. E. Durrant, Crystal Lake, IL (US); Igor G. Stouklov, Walnut, CA (US); Mark C. Benton, Itasca, IL (US)

(73) Assignee: Advanced Fiber Products, LLC, Des Plaines, IL (US)

(21) Appl. No.: 14/205,348

(22) Filed: Mar. 11, 2014

Related U.S. Application Data
(63) Continuation-in-part of application No. 13/109,966, filed on May 17, 2011.
(60) Provisional application No. 61/345,323, filed on May 17, 2010.

(51) Int. Cl. G02B 6/42

(52) U.S. Cl. CPC G02B 6/4251; G02B 6/4274
USPC 385/94

(57) ABSTRACT

A hermetically sealed media converter apparatus configured to operate in harsh high-pressure differential environments, such as deep marine environments, and oil and gas. A hermetically sealed media converter apparatus is provided having a vessel forming an inner chamber that is hermitically sealed from surrounding ambient environment outside the vessel. Media conversion circuitry is contained within the inner chamber. At least one hermetic electrical feedthrough is mounted on the vessel enabling a transmit wire and a receive wire to pass therethrough and connect to the media conversion circuitry, while maintaining the hermetic seal of the inner chamber of the vessel from the surrounding ambient environment. Similarly, a hermetic optical feedthrough also is mounted on the vessel enabling an optical fiber to pass therethrough and connect to the media conversion circuitry, while maintaining the hermetic seal of the inner chamber of the vessel from the surrounding ambient environment.

### CROSS-REFERENCE TO RELATED APPLICATIONS

This is a Continuation-in-Part (CIP) application of U.S. non-provisional application having application Ser. No. 13/109,966, filed on May 17, 2011, which claims priority to U.S. provisional patent application entitled “Pressure Resistance Optical Module,” having application No. 61/345,323, and filed on May 17, 2010, and both the applications set forth above are hereby incorporated by reference.

### BACKGROUND OF THE INVENTION

1. Field of the Invention

The present invention relates generally to media converters, and more particularly, to media converters designed to function in harsh ambient environments.

2. Description of Related Art

Media converters that commonly include optoelectronic transceivers generally include photo-detectors and lasers that convert data signals between optical and electronic transmission formats. Media converters transmit and receive digital optical signals in computers, servers, routers or switches, and are essential subassemblies in these communications systems. Media converters include numerous optical, electronic and optoelectronic components. These optoelectronic components enable media converters to transmit and receive digital or analog optical signals under electronic signal control by converting electronic signals into digital or analog optical signals for transmission over fiber optic cables and networks. Media converters also function by receiving and converting digital optical signals into electronic digital signals for use by the host computers, servers, routers or switches. Since the size of the components is very small in a media converter assembly and they are susceptible to humidity, dirt, dust and multiple other contaminants that can cause degradation, a controlled environment is mandatory for it components to be housed in order to operate efficiently and reliably.

A transmit optical subassembly or TOSA typically comprises, at least, a minimum of a solid-state laser device and a light transmission conductor along with conventional data signal electronic control circuits. These circuits control and drive a solid-state laser in order to generate light pulses under an electronic control. The receive optical subassembly or ROSA, at a minimum, is similarly constituted of a photo-detector and a light transmission conductor together with electronic circuits necessary both to convert the output of a photo-detector into usable electronic data signals and to transmit and condition the output signals of a photo-detector. The photo-detector output signals are generated by light pulses that impinge upon the detection surface of a photo-detector by an associated light transmission conductor.

Typically, optical data signal conductors are optical fibers. The digital light signals are conducted into and out of a transceiver assembly often by very small optical fibers, usually effective propagation elements in the order of 8-10 microns in diameter. Similarly, the exit or the light projection aperture of a solid-state laser is commensurately small. The photo-detector detection surface may be similarly small in high speed devices so that all of the light of the incoming digital signal impinging on the detection surface may be equally susceptible to environmental contaminants and environmental physical influences. With the diameter of the transmission core of an optical fiber being typically 8-10 microns, the placement of and quality of the pulses of light are critical. Light signals must not be attenuated or degraded by contaminants or other external hazards and physical influences on any of the optical fiber end faces, surfaces of lenses, surfaces of reflection suppressors, faces of the optoelectronic components, or in the atmospheric light path.

Very significant efforts are made to create extremely accurate alignments of the optical elements of the system. In more enhanced systems, the digitized optical signal may be passed through one or more lenses and an anti-reflection isolator, and then may be reflected off angled surfaces on the end of an optical fiber to direct, control and position the light pulses properly relative to other optical elements of the system.

Contaminants and other external hazards introduced into or allowed to enter the internal environment of a media converter module may include dust particles, water, water vapor or condensate, dust, fumes, smoke, and even varying ambient pressure changes. Such contaminants and pressure changes may reduce or alter the light signal transmission strength sufficiently to render the media converter unreliable in either or both the “transmit” or “receive” modes of operation.

Even micron-sized particles of dust, debris or other contaminants that settle on or are attracted to the optical surfaces, which coat or block even a portion of the light path, will greatly diminish the optical strength of a signal passing to or from the optoelectronic element. Similarly, if there are lenses or other optical elements in the light path, each of these optical elements may collect dust, particulate contamination, moisture, or a film of contamination on any or all the optical surfaces thereof, and thus prevent the efficient passage of light therethrough. Lasers are very sensitive to moisture, and reflective coatings on facets of some types of lasers, such as a DFB (distributed feedback) laser, are sensitive to condensed moisture as the condensate acts to interfere with the passage of the laser signals therethrough. Similarly, changes in the ambient pressure can distort or disrupt the very sensitive configurations or alignments of these highly sensitive electrical and optical components of a media converter module.

The use of media converter modules continues to expand into various fields, including harsh and hazardous environments. These harsh environments include oil, gas and water, such as with submarine deployments. These harsh environments are often challenged by the inability to protect the sensitive optical coupling elements, such as the interface of the laser and detector devices from the ingress of very high pressure fluids such as seawater or oil. Similarly, when it is necessity to join optical fibers at a connector interface of a media converter module in a marine environment, there can be great difficulties managing cleanliness and pressure differentials to provide reliable and repeatable optical connection performance.

Accordingly, there is a need for a media converter module design that can reliably function and be connected to surrounding wire, electrical and optical connectors and cables in harsh environments, including environments experiencing high ambient pressure differentials.

### SUMMARY OF THE INVENTION

In accordance with the present invention, a hermetically sealed media converter apparatus is provided that is designed to operate in high pressure differential environments, such as deep marine environments. In addition to high-pressure differential environments, the hermetically sealed media converter apparatus of the present invention also is designed to operate in harsh ambient environments such as used in oil and gas production equipment. The hermetically sealed media converter apparatus of the present invention is specifically designed to protect its sensitive electrical and optical internal components in harsh ambient pressure differential environments.

In accordance with the present invention, a hermetically sealed media converter apparatus is provided having a vessel forming an inner chamber that is hermitically sealed from the surrounding ambient environment outside the vessel. A media converter module is contained within the inner chamber having several elements, for example, an opto-detector, a laser transmitter, an electrical transmitter, and an electrical receiver. A hermetic wire or multiples or wire that may be part of a continuous wire cable as a hermetically sealed feedthrough located at a first position on the vessel enabling a transmit wire or wires and/or a receive wire or wires to pass through the first feedthrough of the vessel and connect to the electrical transmitter and/or electrical receiver within the vessel, respectfully, while maintaining the hermetic seal of the inner chamber of the vessel from the surrounding ambient environment. A hermetic optical fiber feedthrough is located at a second entry of the same vessel enabling an optical fiber or fibers also to pass through the vessel, while maintaining the hermetic seal of the inner chamber of the vessel from the surrounding ambient environment. Other wire elements such as those conducting power or monitoring data to and from the media converter within the vessel also may be provided for by supplementary hermetic feedthroughs at some other entry/exit points to the vessel.

The foregoing has outlined, rather broadly, the preferred features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiments as a basis for designing or modifying other structures for carrying out the same purposes of the present invention and that such other structures do not depart from the spirit and scope of the invention in its broadest form.

### BRIEF DESCRIPTION OF THE DRAWINGS

FIGS. 1a and 1b are perspective views of a hermetically sealed media converter apparatus configured in accordance with a preferred embodiment of the present invention;

FIGS. 2a-2d provide additional views of the media converter apparatus shown in FIGS. 1a-1b;

FIGS. 3a-3c illustrate internal components of the media converter apparatus shown in FIGS. 1a-1b and 2a-2d;

FIGS. 4a and 4b illustrate more detailed views of hermetic feedthroughs shown in FIGS. 1a-1b, 2a-d, and 3a-3c;

FIGS. 5a and 5b illustrate detailed views of hermetic feedthroughs configured in accordance with another embodiment of the present invention;

FIGS. 6a and 6b illustrate detailed views of hermetic feedthroughs configured in accordance with a further embodiment of the present invention;

FIG. 7 is a block diagram of circuitry used in a preferred embodiment of the present invention;

FIG. 8 is a cut-away view of the hermetically sealed media converter apparatus shown in FIG. 1a;

FIG. 8a is an enlarged view of the section identified as 8a in FIG. 8; and

FIG. 9 is a cross-section view of an optical fiber feed through end of the hermetically sealed media converter apparatus shown in FIG. 1a.

### DETAILED DESCRIPTION OF THE PREFERRED EMBODIMENTS

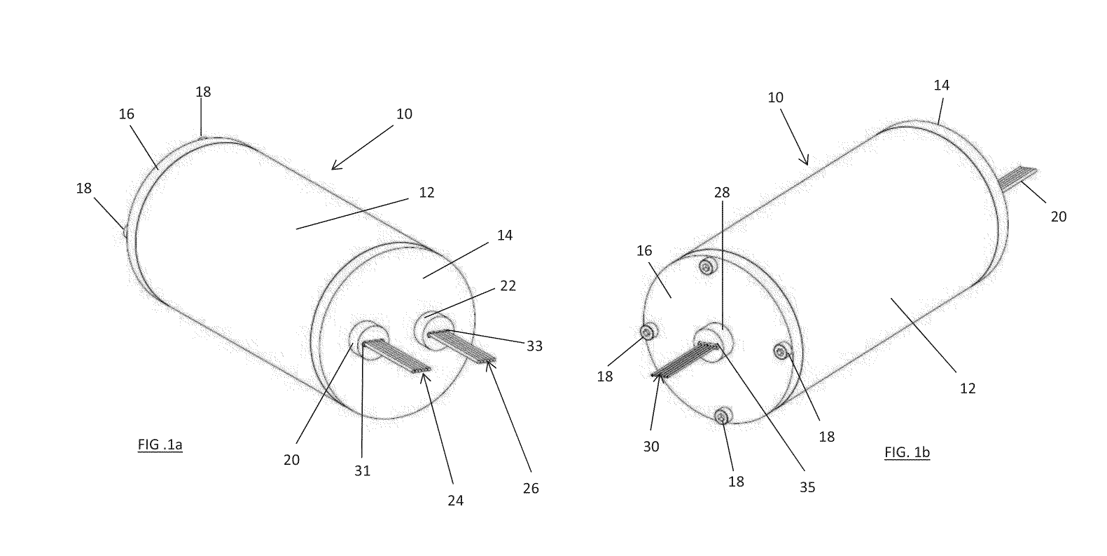

Referring now to the drawings, FIGS. 1a and 1b are perspective views from different ends of a hermetically sealed media converter apparatus 10 configured in accordance with a preferred embodiment of the present invention. FIGS. 1a and 1b illustrate a vessel or capsule 12 having a first end 14 and a second end 16. The first and second ends 14,16 are formed into plates or flanges that are secure and hermetically sealed to opposing open ends of the vessel 12. The vessel 12 is preferably cylindrical in configuration forming an internal chamber inside, but the vessel 12 can also have other configurations in other embodiments, such as a rectangle, square, circle, or even a globe. A cylindrical configuration is particularly suitable for high pressure environments, such as the deep sea. The vessel 12 is preferably constructed of a metal, but may be constructed of other materials, such as a polymer or a ceramic.

The first end or flange 14 is preferably soldered, brazed, welded or glued to an open end of the vessel 12 to form a hermetic seal. The flange 14 also can be hermetically or fluid or liquid or gas tight sealed to an open end of the cylindrical vessel 12 by other known techniques, such as screws or bolts in combinations with rubber O-rings or C-rings. The second end, flange or plate 16 also is hermetically liquid or gas tight sealed to the opposing open end of the vessel 12. The flange 16, similar to flange 14, is hermetically sealed to the other end of vessel 12 by a known technique, described above. Bolts 18 are shown as one of many examples securing the flange 16 to the end of the vessel 12 to form a hermetic seal.

FIG. 1a illustrates hermetic electrical feedthroughs 20,22 for wires. Feedthroughs 20,22 provide hermetic pass throughs for wires. In the illustrated embodiment, wires 24,26 preferably correspond to wire for transmitting signals (TX) and wires for receiving receiving (RX) signals, but not necessarily. FIG. 1b illustrates hermetic optical feedthrough 28 for optical fibers 30. Electrical feedthroughs 20,22 and optical feedthrough 28 are preferably constructed of metal and hermetically sealed to or within an opening in the flanges 14 and 16, respectfully. The electrical feedthroughs 20,22 include apertures 31,33 which provide a passageway for electrical wires. The electrical wires 24,26 are hermetically sealed within the apertures 31,33 by ceramics or glass soldering, metal soldering, brazing, glue, or other known hermetically sealing technique. The wires 24,26 pass completely through the electrical feedthoughs 20,22 from the ambient environment outside the apparatus 10 to the inner chamber within the apparatus 10.

FIG. 1b illustrates a hermetic optical feedthrough 28 having an aperture 35 enabling optical fibers 30 to pass from the outside ambient environment to the inner chamber inside the media converter apparatus 10. The optical fibers 30 are hermetically sealed within the aperture 35 using known techniques, such as glass soldering, metal to glass soldering, or glue. The optical fibers 35 can provide single, bi-directional, or even multiplexed signals on each fiber. The hermetic optical feedthrough 28 is preferably constructed of metal hermetically sealed to or within an opening in the flange 16.

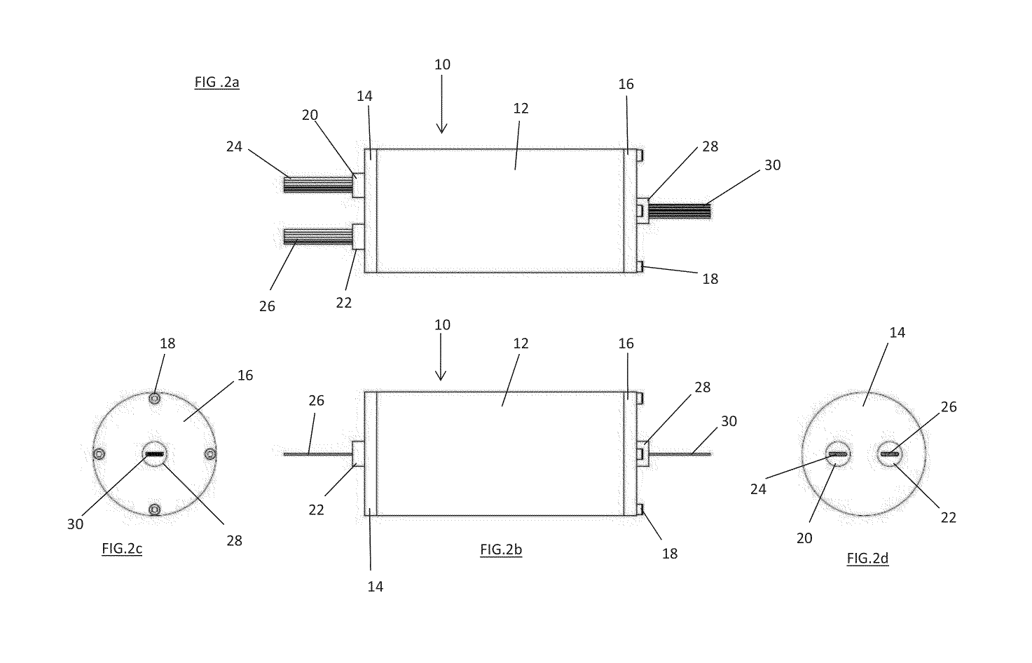

FIG. 2a is top view of the hermetically sealed media converter apparatus 10. Shown are the flange 14 soldered to a first end of the vessel 12, and flange 16 secured to the opposing end of the vessel 12 by bolts 18. Hermetic electrical feedthroughs 20,22 are shown providing a passageway for wires 24,26 from the ambient environment to the inner chamber of the vessel 12. Similarly, the hermetic optical feedthrough 28 is shown providing a passageway for the continuous optical fibers 24 from the ambient environment into the inner chamber of the vessel 12.

FIG. 2b illustrates a side view of the hermetically sealed media converter apparatus 10 providing the vessel 12 and flanges 14,16 and sealing bolts 18. Wires 26 passing through hermitic feedthrough 22 and optical fibers 24 passing through hermetic optical feedthrough 28 also are illustrated.

FIG. 2c provides an end view of flange 16 being hermetically sealed to the vessel 12 by bolts 18. Optical fibers 24 passing through hermetic optical feedthrough 28 also are illustrated.

FIG. 2d is an end view of flange 14. Hermetic electrical feedthroughs 20,22 are shown hermetically sealed to the flange 14, and providing passageways for wires 24,26 to pass from the ambient environment into the inner chamber of the vessel 12.

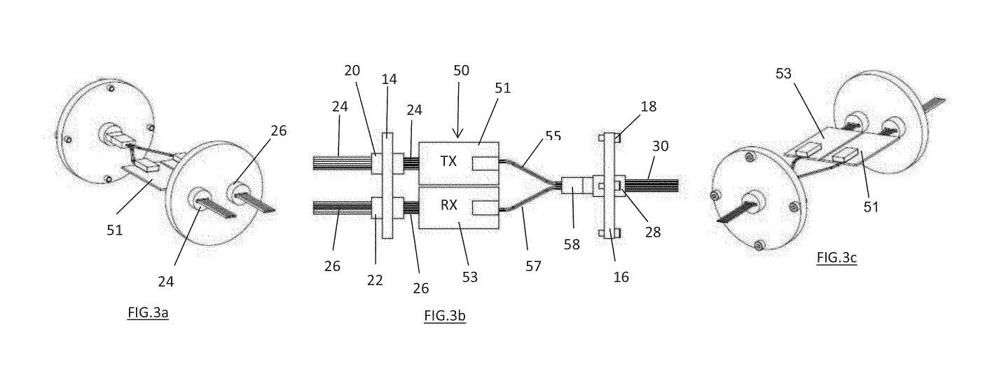

FIGS. 3a-3c illustrates internal components of the hermetically sealed media converter apparatus 10. FIGS. 3a-3c illustrate media conversion circuitry 50 for use with an optoelectronic transceiver 58 utilizing, for example, VCSEL components coupled to the internal end of the hermetic optical feedthrough 28. Wires 24 pass through the hermetic electrical feedthrough 20 and connect to the transmit media conversion circuitry board 51. Similarly, wires 26 pass through the hermetic electrical feedthrough 22 and connect to the receive media conversion circuitry board 53. Transmit (TX) wires 55 and receive wires (RX) 57 connect the transmit and receive media conversion circuit boards 51,53 to the optoelectronic transceiver 58. The optoelectronic transceiver 58 is directly connected to the internal end of the hermetic optical feedthrough 28. The optical fibers 24 pass through the hermetic optical feedthrough 28 and connect to the optoelectronic transceiver 58.

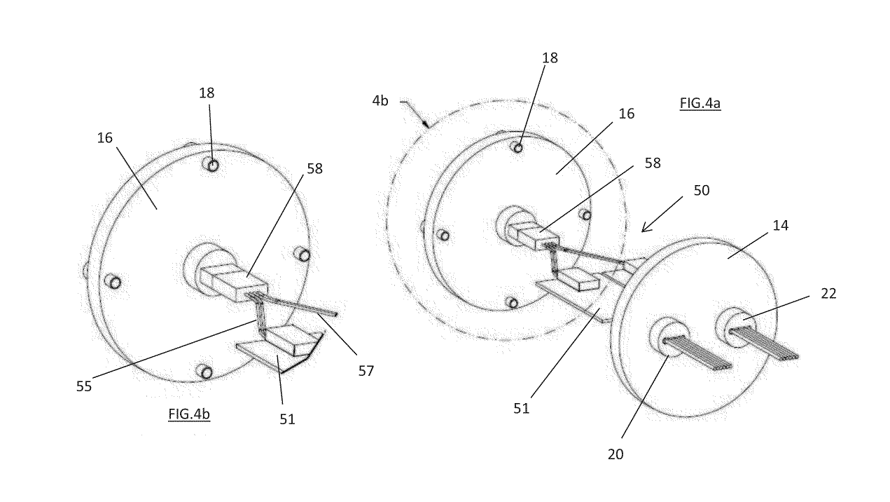

FIG. 4a illustrates an enlarged view of the media conversion circuitry 50 connected to the optoelectronic transceiver 58, which is directly connected to the internal end of the hermetic optical feedthrough 28. FIG. 4b provides a further enlarged view of the optoelectronic transceiver 58 connected to wires 55,57, which in turn are connected to the media conversion circuitry 50.

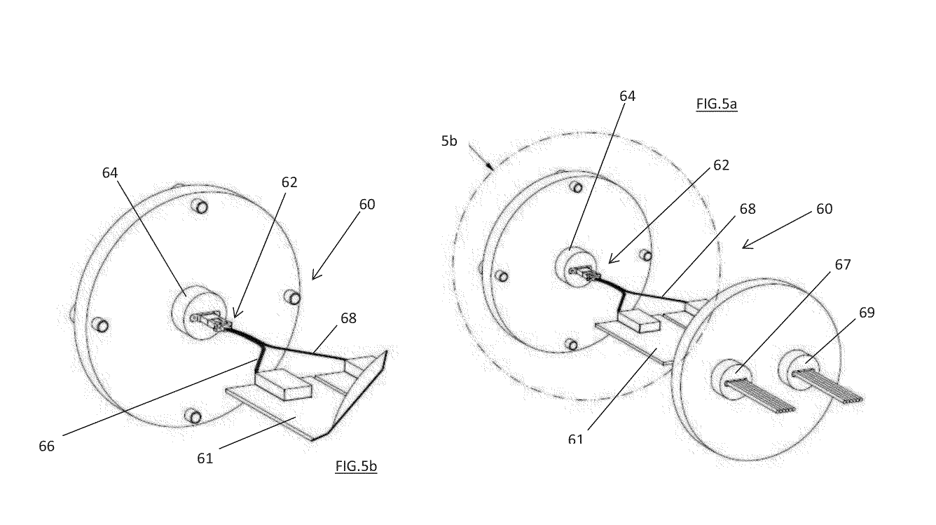

FIG. 5a. illustrated an enlarged view of media conversion circuitry 60 to be located within the inner chamber of the vessel 12. This media conversion circuitry 60 is configured in accordance with another embodiment of the present invention and utilizes an MT ferrule 62 connected to a hermetic optical feedthrough 64. The media conversion circuitry 60 is connected to the MT ferrule 62 by optical pigtails 66,68. FIG. 5b provides a more detailed view of the MT ferrule 62 and optical pigtails 66,68.

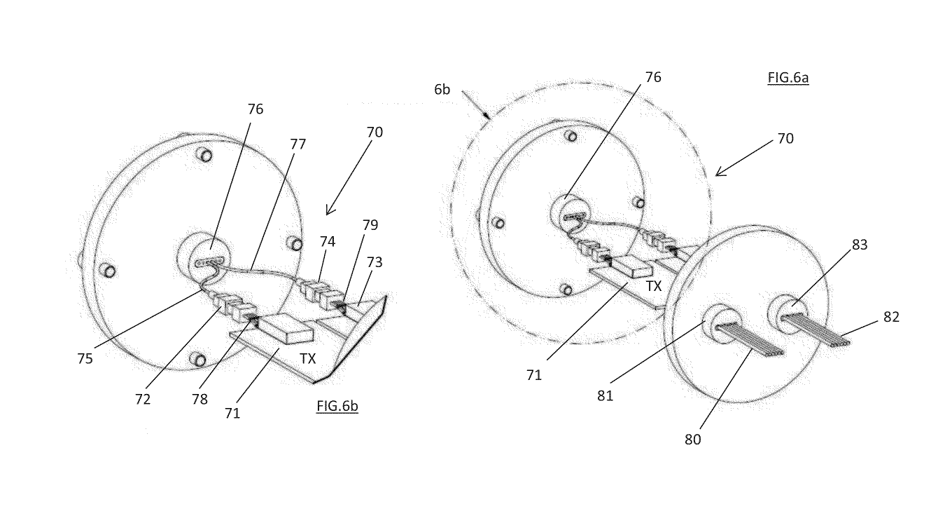

FIG. 6a illustrates an enlarged view of media conversion circuitry 70 to be located within the inner chamber of the vessel 12. FIG. 6b provides a further enlarged view of the media conversion circuitry 70. The media conversion circuitry 70 is configured in accordance with another embodiment of the present invention and utilizes a TOSA 72 and a ROSA 74 connected between a hermetic optical feedthrough 76 and electrical media conversion transmit circuitry 71 and electrical media conversion receive circuitry 73. Optical fiber 75 passes from the ambient environment outside the vessel 12, through the hermetic optical feedthrough 76 and to the TOSA 72 within the inner chamber of the vessel 12. Electrical wires 78 connect the TOSA 72 to the electrical media conversion transmit circuitry 71. Similarly, optical fiber 77 passes from the ambient environment outside the vessel 12, through the hermetic optical feedthrough 76 and to the ROSA 74 within the inner chamber of the vessel 12. Electrical wires 79 connect the ROSA 74 to the electrical media conversion receive circuitry 73.

On the electrical side of the media conversion circuitry 70, electrical wires 80 pass through the hermetic electrical feedthrough 81 and to the electrical transmit media conversion circuitry 71, and electrical wires 82 pass through the hermetic electrical feedthrough 83 and connect to the electrical receive media conversion circuitry 73.

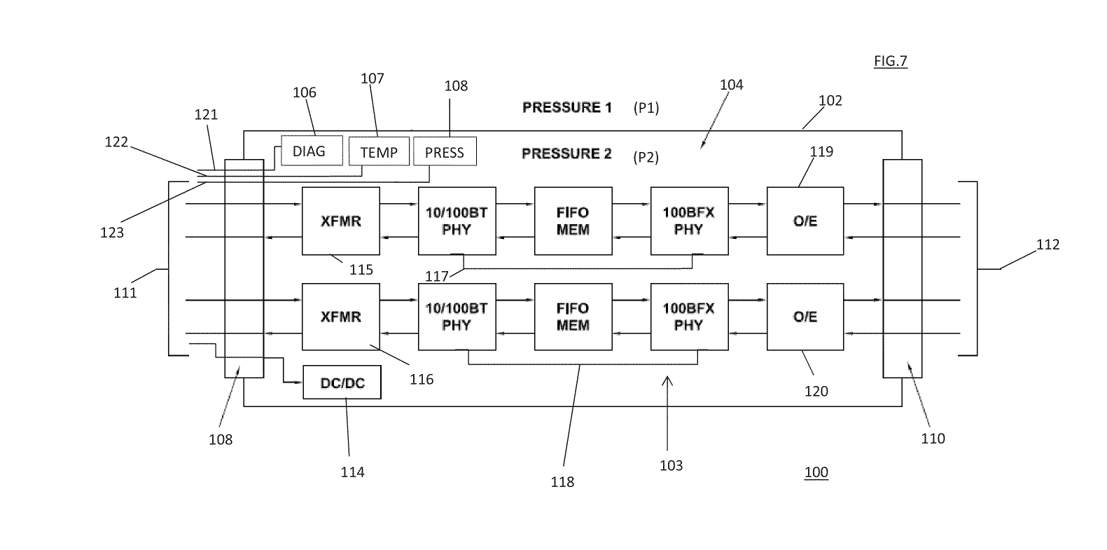

FIG. 7 illustrates a block diagram of a media converter apparatus 100 configured in accordance with the present invention. In order to achieve an aspect of the invention, the media converter apparatus 100 includes an airtight and watertight vessel 102 capable of protecting the media conversion circuitry 104 contained inside the vessel 102.

In accordance with a further important aspect of the present invention, the hermetically sealed vessel 102 maintains a consistent Pressure 2 (P2) which is not affected by changes in the external ambient Pressure 1 (P1). The internal Pressure 2 (P2) can be close to a vacuum, pressure approximate at sea level, or a pressure exceeding sea level, whatever pressure is desired to be maintained by a user, which is independent of changes in the ambient pressure P1.

Turning now to other components within the media converter apparatus 100, a hermetic electrical feedthrough 108 and a hermetic optical feedthrough 110 are hermetically sealed on opposing open ends of the vessel 102 and in some embodiments could be the same end or penetration point of the vessel, which preferably has a cylindrical configuration. Electrical wires 111 pass through the hermetic electrical feedthrough 108 into the hermetically sealed inner chamber 103 of the vessel 102 and connect to the media conversion circuitry 104. These wires could similarly be entering and exiting the vessel through the same hermetic penetration element as the optical fibers in some configurations. Similarly, optical fibers 112 pass through a hermetic optical feedthrough 110 from the ambient environment having pressure P1 to the inner chamber 103 having pressure P2, and connect to the media conversion circuitry 104.

In accordance with an additional aspect of the present invention, a diagnostic circuit 106 is included within the inner chamber 103 to be connected to and monitor operation of the media conversion circuitry 104. The diagnostic circuit is 106 is connected to a system controller via a communication wire 121 passing through the hermetic electrical feedthrough 108. A temperature sensor or temperature transducer 107 is located within the inner chamber 103 to monitor the temperature within the inner chamber 103. The temperature sensor 107 is connected to a system controller via a communication wire 122 passing through the hermetic electrical feedthrough 108. A pressure senor or pressure transducer 108 is located within the inner chamber 103 to monitor pressure within the inner chamber 103. The pressure sensor 108 is connected to a system controller via a communication wire 123 passing through the hermetic electrical feedthrough 108.

A DC/DC transformer 114 receives power via the hermetic electrical feedthrough 111 and provides power to the media conversion circuitry 104. On the electrical side of the media conversion circuitry 104, electrical wires 111 are first received by isolation transformers 115,116, which in turn are electrically connected to Ethernet chip sets 117,118. Similarly, optical fibers 112 pass through the hermetic optical feedthrough 110 and connect to optoelectronic transceivers 119,120, which are electrically connected to the Ethernet chip sets 117,118.

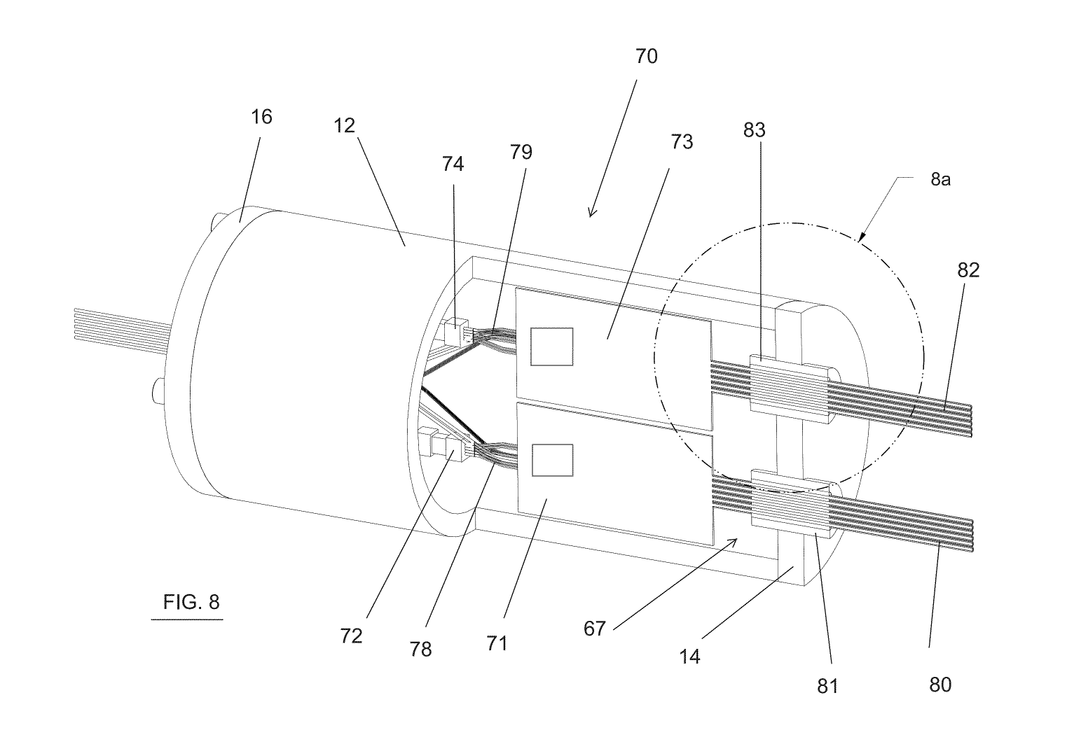

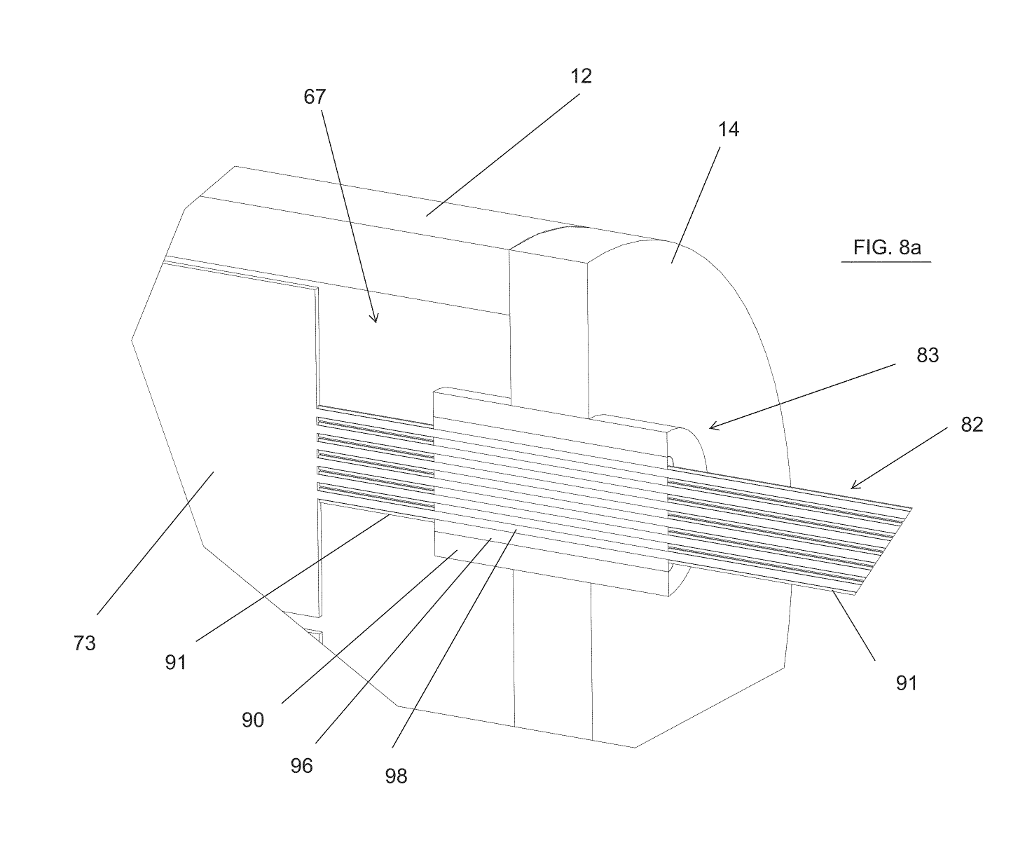

FIG. 8 illustrates a cutout of the vessel 12 shown FIGS. 1a and 1b, illustrating media conversion circuitry 70 shown in FIGS. 6a and 6b located within the inner chamber 67 of the vessel 12. The media conversion circuitry 70 includes a TOSA 72 and a ROSA 74 connected between a hermetic optical feedthrough 76 (FIG. 6a) and electrical media conversion transmit circuitry 71 and electrical media conversion receive circuitry 73. Electrical wires 78 connect the TOSA 72 to the electrical media conversion transmit circuitry 71. Continuous electrical wires 79 connect the ROSA 74 to the electrical media conversion receive circuitry 73. End walls 14 and 16 are hermetically sealed on opposing ends of the vessel 12 to form the hermetically sealed inner chamber 67.

On the electrical side of the media conversion circuitry 70, electrical wires 80 pass without interruption through the hermetic electrical feedthrough 81 and to the electrical transmit media conversion circuitry 71, and electrical wires 82 pass without interruption through the hermetic electrical feedthrough 83 and connect to the electrical receive media conversion circuitry 73.

FIG. 8a illustrates an enlarged view of the electrical side of the media converter apparatus 10. The end wall 14 is hermetically sealed to the vessel 12. The illustrated hermetically sealed inner chamber 67 includes the electrical receive media conversion circuitry 73 and electrical wires 82 passing through the hermetic electrical feedthrough 83 and connecting to the electrical receive media conversion circuitry 73.

In accordance with the present invention, a hermetically sealed media conversion apparatus is provided having hermetic feedthroughs or penetrators enabling electrical wires and optical fibers to pass through the outer walls of the vessel unobstructed and continuous without performance loss so as to maximized transmission efficiency while maintaining a hermetical seal in high pressure ambient environments. Optical fibers and electrical wires pass through the feedthroughs without any change to the fiber or wire, such as splicing or passing through a connector. The feedthroughs are essentially “transparent” to electrical wires and optical fibers passing therethrough because the electrical wires and optical fibers pass through unaffected. This design enables optical fibers to avoid virtually any no attenuation or change in polarization of transmitted light signals or general performance degradation. The feedthrough or penetrator 83 enables electrical wires to pass through the end wall 14 while maintaining a hermetic seal capable of withstanding high pressure ambient environments, such as 20 k PSI. When referring to “feedthroughs” or “penetrators” in this application, the inventors have defined these terms to means locations where electrical wires or optical fibers pass through the outer walls of the vessel unobstructed and continuous so as to maximized transmission efficiency of electrical wires and optical fibers while maintaining a hermetical seal in high pressure ambient environments.

As illustrated in FIG. 8a, and in accordance with the present invention, insulation 91 of copper conductors 98 in the electrical wires 82 is stripped away only for the section of the electrical wires 82 passing through the feedthrough 83. The copper conductors 98 of the electrical wires 83 are then typically glass-to-glass sealed between each of the copper conductors 98 of the electrical wires 82, and the copper conductors 98 are typically glass-to-metal sealed 90 to the end wall 14.

Feedthroughs are produced by sealing onto the conductor itself. Sealing to the fiber or wire jacket will not generate a ‘hermetic’ feed through. The outer protection jackets or insulators have to be locally ‘window stripped’ by chemical or mechanical processes with great care and complexity without damage to the conductor to expose a short length of the electrical or optical conductor onto which a seal can be made between the vessel and the conductor itself. It is preferable to maintain the full protection of the conductor on both sides of the hermetic seal, hence also the ‘window stripping’ technology.

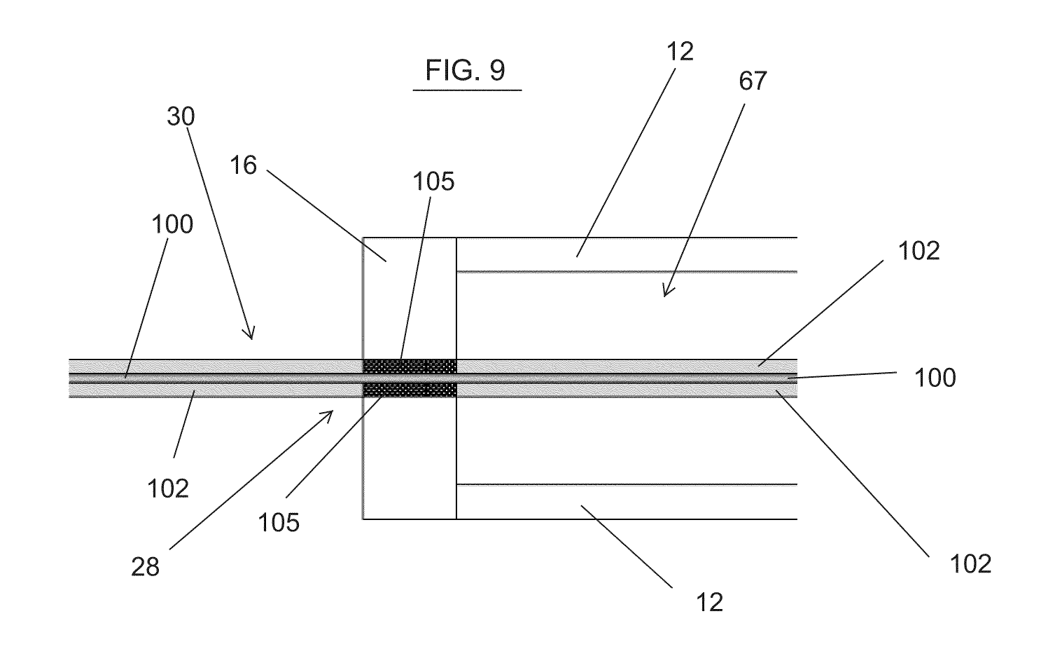

FIG. 9 is a cross-sectional view of the optical end of the media conversion apparatus 10 shown in FIG. 1b. Illustrated is the vessel 12 having a hermetically sealed environment 67. An end wall 16 is hermetically sealed to the vessel 12. The optical fiber 30 is shown passing through the optical feedthrough 28. The optical fiber 30 includes cladding 102 and core 100.

In accordance with the present invention, the cladding and/or protection sheathing 102 remains on the optical fiber 30 immediately before and after the optical feedthrough 28. Within the feedthrough 28, the cladding 102 on the optical fiber 30 is stripped, and the optical core 100 is glass-to-metal sealed 105 to the end wall 16. In this manner, the feedthrough 28 provides a high pressure hermetic seal, while further enabling the optical core 100 to pass through the end wall 16 without obstructing, splicing, or affecting the efficiency of the optical transmission medium.

While specific embodiments have been shown and described to point out fundamental and novel features of the invention as applied to the preferred embodiments, it will be understood that various omissions and substitutions and changes of the form and details of the apparatus illustrated and in the operation may be done by those skilled in the art, without departing from the spirit of the invention.

1. A hermetically sealed media converter apparatus, comprising:
a vessel forming an inner chamber that is hermetically sealed from a surrounding ambient environment outside the vessel, said vessel including a first end and a second end;
media conversion circuitry contained within the inner chamber;
an optoelectronic transceiver connected to the media conversion circuitry and contained within the inner chamber;
a high-pressure hermetic electrical feedthrough on the first end of the vessel including a wire passing completely through the hermetic electrical feedthrough, wherein insulation of the wire is removed within the feedthrough; and
a high-pressure hermetic optical feedthrough on the second end of the vessel including an optical fiber passing completely through the hermetic optical feedthrough, wherein cladding of the optical fiber is removed within the feedthrough.

2. The media converter apparatus of claim 1, wherein the ambient environment includes water.

3. The media converter apparatus of claim 1, wherein the hermetic seal of the vessel maintains a constant internal pressure despite greater external pressures.

4. The media converter apparatus of claim 1, wherein the first and second ends are at opposing locations of the vessel.

5. The media converter apparatus of claim 1, wherein the media conversion circuitry comprises at least one of a physical chip and chip set.

6. The media converter apparatus of claim 1, further comprising:
a pressure sensor and a temperature sensor contained within the inner chamber to be directly connected to and providing real-time sensor data to an external host.

7. The media conversion apparatus of claim 1, further comprising:
a pressure sensor within the inner chamber for monitoring pressure within the inner chamber and reporting inner chamber pressure data back over an optical link.

8. The media conversion apparatus of claim 5, wherein the at least one of a physical chip and a chip set includes a 10/100BT PHY electrical interface, a first-in first-out memory, and a 100BFX PHY optical interface.

9. The media converter apparatus of claim 1, wherein the vessel has a cylindrical configuration, and the media converter apparatus further comprising:
a first flange hermetically sealed to the first end of the cylindrical vessel, and the hermetic electrical feedthrough is mounted within an aperture in the first flange; and
a second flange hermetically sealed to the second end of the cylindrical vessel, and the hermetic optical feedthrough is mounted within an aperture in the second flange.

10. A hermetically sealed media converter apparatus, comprising:
a vessel forming an inner chamber that is hermitically sealed from surrounding ambient environment outside the vessel;
media conversion circuitry contained within the inner chamber;
an optoelectronic transceiver connected to the media conversion circuitry and contained within the inner chamber; and
a high-pressure hybrid hermetic electrical and optical feedthrough on the vessel including both a wire and an optical fiber to passing completely through the hybrid hermetic feedthrough and maintaining a consistent configuration a substantial distance before, during, and after passing through the hybrid hermetic feedthrough, and connect to the media conversion circuitry and the optoelectronic transceiver, while maintaining the hermetic seal of the inner chamber of the vessel from the surrounding ambient environment.

11. The media conversion apparatus of claim 8, further comprising:
an isolation transformer (XFMR) contained within the inner chamber of the vessel and electrically connected to the hermetic electrical feedthrough.

12. The media converter apparatus of claim 1, wherein the electrical wire maintains a straight path and a consistent configuration while completely passing though the electrical feedthrough, and the optical fiber maintains a straight path and a consistent configuration while completely passing though the optical feedthrough .
